(19) United States
(12) Patent Application Publication
(10) Pub. No.: US 2005/0033835 A1
(43) Pub. Date: Feb. 10, 2005

(54) Device control system, device control method for use in the device control system, and program for implementing the device control method

(75) Inventor: Naoto Kinjo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/885,095

(22) Filed: Jul. 7, 2004

(30) Foreign Application Priority Data
Jul. 7, 2003 (JP) 2003-192985

(51) Int. Cl. G06F 15/173; H04N 5/232

(52) U.S. Cl. 709/223; 348/211.3

(57) ABSTRACT

A device control system includes plural devices arranged in a predetermined space, a position detection unit for detecting an arrangement position of each device, a control unit for remotely controlling the plural devices, being carried by a user, and detecting a direction and a position of itself at the time of remote control and a management apparatus that grasps the arrangement position of each device and identifies one device to be remotely controlled based on the arrangement position and the direction and the position. A device control method detects the arrangement position, the position and the direction, identifies one device to be remotely controlled and remotely controls the one device. A program implements the device control method.

### BACKGROUND OF THE INVENTION

The present invention relates to a device control system where a control means (remote controller, for instance) is directed toward one of devices (electrical appliances, for instance) and is used to remotely control the device. The present invention also relates to a device control method for use in the device control system and a program for implementing the device control method.

Conventionally, various techniques have been proposed with which it is possible to control multiple devices with a single remote control unit (hereinafter referred to as “remote controller”) (see JP 2001-95070 A and JP 11-110109 A, for instance).

In JP 2001-95070 A, a remote controller is disclosed which includes a remote control main body, a video input means, an image display and input panel means, and an audio input means. The remote controller main body includes various interfaces for establishing connection between the video input means, the image display and input panel means, and the audio input means, a central processing unit (CPU) for processing data inputted/outputted via those interfaces, and a memory for storing the data.

The remote controller as disclosed in JP 2001-95070 A is capable of taking in control information concerning each device from the video input means, a medium, or the audio input means and controlling the device. At this time, the remote controller is also capable of acquiring GUIs (graphical user interfaces) for control together with the control information, with a GUI corresponding to a device to be controlled being displayed on a touch panel of the image display and input panel means. By touching each required button of this GUI, a user controls the device with the remote controller. As described above, the remote controller as disclosed in JP 2001-95070 A has a construction where multiple remote controllers have been integrated into a single remote controller, which facilitates control of household electrical appliances.

Also, in a centralized control system as disclosed in JP 11-110109 A, multiple AV (audio and visual) devices forming an AV device group are connected to a device control apparatus and a host computer constituting a host system for selectively causing an arbitrary AV device in the AV device group to operate. In addition, a portable information communication device (hereinafter referred to as “PDA (personal digital assistant)” that performs wireless communication with the host computer and issues an operation command with respect to the arbitrary AV device is provided in the centralized control system. This PDA is integrally provided with a display and a touch panel input device. Also, in the PDA, switching between a remote control mode, in which a GUI remote controller display screen for issuing an operation command to a device to operate is displayed, and an information processing mode, in which an independent control screen for performing information processing is displayed, is automatically performed in accordance with the current position of the portable information communication device and an image corresponding to a mode currently set is displayed on the display. Here, the automatic mode switching is performed with reference to a distance between the PDA and the host computer.

When the GUI remote controller display screen is displayed, for instance, it is possible for a user to cause an arbitrary AV device to perform a desired operation by selecting the arbitrary AV device and operating the touch panel input device. In addition, it is also possible for the user to perform displaying on a screen of a device in the AV device group or the display of the PDA by operating each required key displayed on the GUI remote controller display screen.

In the case of the remote controller as disclosed in JP 2001-95070 A, however, there arises a problem in that a hardware construction becomes excessively large.

On the other hand, in the case of the centralized control system as disclosed in JP 11-110109 A, the device selection is performed using the GUI remote controller display screen displayed on the display. When the number of AV devices in the AV device group becomes large, the number of control steps is increased and a control procedure becomes complicated, which results in a problem in that the user should be well accustomed to control using the PDA.

### SUMMARY OF THE INVENTION

The present invention has been made in order to solve the problems described above and has an object to provide a device control system in which it is possible to remotely control multiple devices such as electrical appliances with a single control means such as a remote controller or a mobile telephone by identifying a device, out of the multiple devices, toward which the control means is directed. Also, the present invention has another object to provide a device control method for use in the device control system and a program for implementing the device control method.

In order to attain the above-mentioned object, the first aspect of the present invention provides a device control system comprising: plural devices arranged in a predetermined space; position detection means for detecting an arrangement position of each of the plural devices in the predetermined space; control means for remotely controlling the plural devices, the control means being carried by a user of the plural devices, being directed toward the arrangement position of one device of the plural devices to be remotely controlled, and detecting a direction and a position of itself in the predetermined space at the time of remote control of one device; and a management apparatus that acquires the arrangement position of each of the plural devices detected by the position detection means, and identifies one device to be remotely controlled by the control means based on the arrangement position of each of the plural devices and the direction and the position of the control means, wherein the control means remotely controls the identified one device via the management apparatus.

Preferably, at least one of the plural devices comprises an image display apparatus; and when the identified one device is the image display apparatus, the management apparatus outputs image data to the image display apparatus to display a predetermined image, and the image display apparatus displays the predetermined image based on the image data.

Preferably, the control means has a voice communication function; the management apparatus includes a voice search unit for searching information based on voice contents inputted from the control means and a database in which the information to be searched by the voice search unit has been stored; and the voice search unit searches the database for information matching the voice contents based on the voice contents inputted by voice with the control means, and when the one device to be remotely controlled with the control means comprises an image display apparatus, the management apparatus outputs a searched result by the voice search unit to the image display apparatus.

Further Preferably, the searched result is image data; and the management apparatus transmits the image data to the image display apparatus and causes the image display apparatus to display an image based on the image data.

Preferably, at least one of the plurality of devices comprises a photographing device provided for a article; the control means includes an image display unit; the photographing device photographs the article and outputs data of a photographed image of the article to the control means directly or via the management apparatus; and the control means displays an image of the article on the image display unit based on the data of the photographed image.

Preferably, the control means has an image display unit; and after acquiring information concerning one device to be remotely controlled with the control means, the management apparatus transmits the information concerning one device to the control means to display the information concerning one device on the image display unit.

Preferably, the control means has at least one of a reception function of acquiring data concerning one device to be remotely controlled directly or via the management apparatus and a transmission function of outputting the data concerning one device to be remotely controlled directly or via the management apparatus.

Preferably, the plurality of devices contain a first device and a second device to be remotely controlled by the control means; and the control means has a function of causing the first device as a target of remote control to transmit data held therein to the management apparatus and a function of causing the management apparatus to transmit data held therein to the second device as a target of the remote control.

In order to attain the above-mentioned object, the second aspect of the present invention provides a device control system comprising: image display means for displaying an image at a specific place; pointing means for pointing a predetermined place, the pointing means being carried by a user and having a function of detecting a position and a direction of itself; and a management apparatus that acquires the position and the direction detected by the pointing means, identifies as the specific place the predetermined place pointed by the pointing means based on the acquired position and the acquired direction, and causes the image display means to display the image at the identified predetermined place, wherein the image is displayed by the image display means at the predetermined place pointed by the pointing means via the management apparatus.

Preferably, the pointing means further has an information communication function.

It should be noted here that in the present invention, the term “device” means a storage apparatus that records data on various recording media, an image display apparatus, a printer, a facsimile, a refrigerator, a personal computer, a portable communication apparatus such as a mobile telephone or a PDA, or the like, for instance. Also, the term “commodity” means a storage shed, a desk, a bookshelf, a chest, a locker, or the like.

And, in order to attain the above-mentioned object, the third aspect of the present invention provides a device control method comprising the steps of: detecting an arrangement position of each of plural devices arranged in a predetermined space; detecting a position and a direction of control means that is carried by a user of the plural devices and has a function of remotely controlling the plural devices; identifying one device of the plural devices toward which the control means is directed by the user, based on detection results of the arrangement position of each of plural devices and the position and the direction of the control means; and remotely controlling the identified one device of the plural devices by means of the control means.

And, further, the fourth aspect of the present invention provides a program for implementing a device control method comprising: a step of acquiring first position information concerning plural devices arranged in a predetermined space from first position detection means for detecting an arrangement position of each of the plural devices, and identifying the arrangement position of each of the plural devices in the predetermined space based on the acquired first position information; a step of acquiring second position information concerning a control means for remotely controlling the plural devices from a second position detection means for detecting a position and a direction of the control means, and identifying the position and the direction of the control means based on the second position information; a step of identifying one device of the plural devices, toward which the control means is directed, based on the identified arrangement position of each of the plural devices and the identified position and the identified direction of the control means; and a step of outputting, to the control means, a signal for obtaining a state where the identified one device is controllable with the control means.

This application claims priority on Japanese patent application No. 2003-192985, the entire contents of which are hereby incorporated by reference.

### BRIEF DESCRIPTION OF THE DRAWINGS

In the accompanying drawings:

FIG. 1 is a schematic diagram showing a device control system according to a first embodiment of the present invention;

FIG. 2 is a schematic diagram showing a construction of a remote controller used in the device control system according to the first embodiment of the present invention;

FIG. 3 is a schematic diagram showing a device control system according to a second embodiment of the present invention;

FIG. 4 is a schematic diagram showing a device control system according to a third embodiment of the present invention;

FIG. 5 is a schematic diagram showing a device control system according to a fourth embodiment of the present invention;

FIG. 6 is a schematic diagram showing a device control system according to a fifth embodiment of the present invention;

FIG. 7 is a schematic diagram showing a construction of a remote controller used in the device control system according to the fifth embodiment of the present invention; and

FIG. 8 is a schematic diagram showing a device control system according to a sixth embodiment of the present invention.

### DETAILED DESCRIPTION OF THE PREFERRED EMBODIMENTS

A device control system, a device control method, and a program according to the present invention will now be described in detail with reference to embodiments shown in the accompanying drawings.

<First Embodiment>

FIG. 1 is a schematic diagram showing a device control system according to a first embodiment of the present invention.

As shown in FIG. 1, a device control system 10 in this embodiment includes a server (management apparatus) 14, a position detection means composed of IC tags 16a to 16d and IC tag sensors 18a to 18d, a device and commodity group 20 including multiple devices and commodities arranged in a predetermined space, and a remote controller (control means) 30 carried and used by a user. In the device control system 10 in this embodiment, the multiple devices and commodities in the device and commodity group 20 are controlled with the single remote controller 30.

In the device control system 10 in this embodiment, the IC tag sensors 18a to 18d are provided in a wall 12 and the positions of these IC tag sensors 18a to 18d are identified in advance. A household electrical appliance 22, an AV device 24, a desk 26, and a storage shed 28 are arranged along the wall 12. Also, the household electrical appliance 22, the AV device 24, the desk 26, and the storage shed 28 constitute the device and commodity group 20. Further, the IC tags 16a to 16d are provided for the household electrical appliance 22, the AV device 24, the desk 26, and the storage shed 28, respectively. In each of the IC tags 16a to 16d, information unique to the device or commodity, for which the IC tag is provided, has been recorded.

In the position detection means, each of the IC tag sensors 18a to 18d detects its corresponding one of the IC tags 16a to 16d provided for the devices and commodities, which makes it possible to identify each device and each commodity. Therefore, the position of each device or commodity is identified.

The server 14 grasps the position of each device or commodity in the device and commodity group 20 based on position information concerning the device or commodity from the position detection means. Also, based on position and direction information concerning the remote controller 30, the server 14 identifies which device or commodity in the device and commodity group 20 is pointed by a user with the remote controller 30, as will be described later.

In addition, the server 14 manages and controls each device, such as the household electrical appliance 22 or the AV device 24, in a centralized manner. Also, the server 14 is capable of communicating with the remote controller 30, causing an image display unit 32 of the remote controller 30 to display a control screen for controlling a device in the device and commodity group 20 toward which the remote controller 30 is directed, and controlling the device based on each signal inputted from the remote controller 30. With this construction, it becomes possible for the user to remotely control each device, which he/she wishes to remotely control, with the remote controller 30 via the server 14.

Here, it is preferable that at least one of the devices in the device and commodity group 20 is a device, such as a television set or a monitor of a personal computer (hereinafter abbreviated to the “PC”), which has an image display unit and is capable of displaying an image.

The remote controller 30 is capable of detecting the position and direction of the controller itself in the device control system 10 and is used to remotely control each device. This remote controller 30 is directed toward any one of the devices and commodities in the device and commodity group 20 and is used to remotely control the device or commodity.

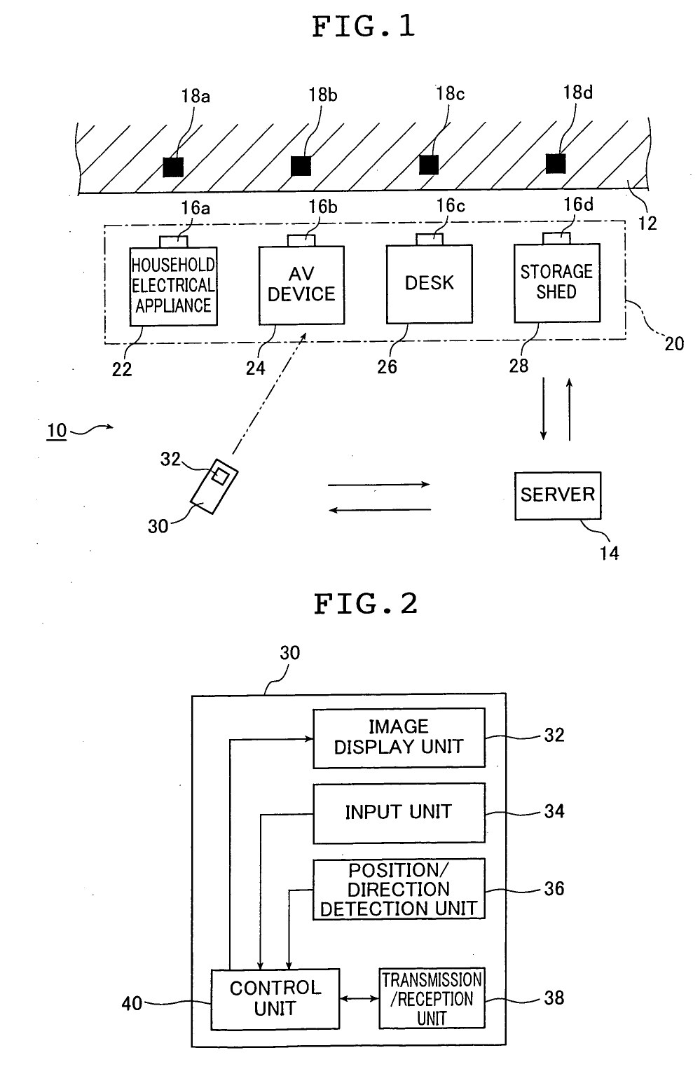

FIG. 2 is a schematic diagram showing a construction of the remote controller used in the device control system according to the first embodiment of the present invention.

As shown in FIG. 2, the remote controller 30 includes an image display unit 32, an input unit 34, a position/direction detection unit 36, a transmission/reception unit 38, and a control unit 40.

The image display unit 32 is used to display a control panel image corresponding to each device and is connected to the control unit 40. Based on image data outputted from the server 14 or each device in the device and commodity group 20, a predetermined control panel image is displayed on the image display unit 32. This control panel image is a GUI screen, for instance.

It should be noted here that examples of the image display unit 32 are a liquid crystal display, a plasma display, an organic EL device, and the like. Here, the operation status of a device to be controlled may also be displayed on the image display unit 32.

The input unit 34 includes an input device for controlling each device and is connected to the control unit 40. In this embodiment, an input device of touch panel type is integrally provided for the image display unit 32. By touching the control panel screen displayed on the image display unit 32 with a finger or the like, the user controls a device that is a control target so as to perform a predetermined operation.

The position/direction detection unit 36 detects the position and direction of the remote controller 30 itself. As a method of detecting the position, for instance, it is possible to use a method with which IC tags holding position information are arranged at predetermined intervals in a building, an IC tag sensor is provided for the remote controller 30, and the IC tags are read by the IC tag sensor provided on a remote controller 30 side. Aside from this, it is possible to use a method using a Global Positioning System (GPS) or a method with which transmitters are provided at specific points in a building, radio waves transmitted from these transmitters are received with the transmission/reception unit 34 or the like, and the position of the remote controller 30 is calculated using the received radio waves. Also, it is possible to detect the direction of the remote controller 30 using a terrestrial magnetism sensor or a gyrosensor, for instance. The position/direction detection unit 36 is connected to the control unit 40. Note that as to position information concerning the remote controller 30, the present invention is not limited to the method with which the position information is obtained by the remote controller 30 itself. For instance, like in the case of the device and commodity group 20, an IC tag may be provided for the remote controller 30 and the position of the remote controller 30 may be detected and grasped by the server 14.

The transmission/reception unit 38 transmits and receives various kinds of data to be exchanged between the remote controller 30 and the server 14 and between the remote controller 30 and the device and commodity group 20, and is connected to the control unit 40.

The control unit 40 controls the image display unit 32, the input unit 34, and the position/direction detection unit 36. This control unit 40 outputs image data to the image display unit 32 so that a predetermined image is displayed on the image display unit 32. Also, the control unit 40 causes the transmission/reception unit 38 to output an input signal from the input unit 34 to the server 14. Further, the control unit 40 causes the transmission/reception unit 38 to output the position information and the direction information concerning the remote controller 30 detected by the position/direction detection unit 36 to the server 14.

Next, a device control method used in the device control system 10 in this embodiment will be described. Note that the program according to the present invention is a program for implementing the device control method to be described in detail below.

First, the user directs the remote controller 30 toward a device that he/she wishes to remotely control. Here, the position/direction detection unit 36 constantly detects the position and direction of the remote controller 30 in the device control system 10.

Next, position information and direction information concerning the remote controller 30 are outputted to the server 14.

Then, with reference to the position information and the direction information concerning the remote controller 30 and position information concerning each device in the device and commodity group 20, the server 14 identifies toward which device the remote controller 30 is directed by the user. In this manner, a device to be remotely controlled with the remote controller 30, that is, a device, toward which the user directs the remote controller 30, is identified.

Next, image data of a control panel image corresponding to the device to be remotely controlled with the remote controller 30 (signal for obtaining a controllable state) is outputted from the server 14.

Then, the control panel image is displayed on the image display unit 32 based on the image data sent from the server 14 to the control unit 40 via the transmission/reception unit 38. As a result, the device to be remotely controlled with the remote controller 30 is placed under a controllable state.

Next, the user inputs a command by operating the input unit 34 provided integrally with the image display unit 32 while viewing the control panel image. Then, command input information is outputted to the server 14 by the transmission/reception unit 38 and is further outputted to the device to be remotely controlled from the server 14. With this construction, it becomes possible for the user to remotely control each device, which he/she wishes to remotely control, by inputting each required command using the single remote controller 30.

It should be noted here that in this embodiment, the input unit 34 is a touch panel provided integrally with the image display unit 32, although the present invention is not specifically limited to this. For instance, the input unit 34 may be provided separately from the image display unit 32 and include multiple control keys or input buttons.

Also, in this embodiment, the server 14 may be connected to a network outside the device control system 10. In this case, the server 14 may search for information concerning an identified device in accordance with each command inputted from the user and the information may be displayed on the image display unit 32. In this case, if the device and commodity group 20 includes a device having an image display unit that is capable of displaying an image, the information concerning the identified device may be displayed on the image display unit of the device.

Further, in this embodiment, in the case of a device or commodity having a housing, such as a refrigerator, a storage shed, a desk, or a chest, a photographing device that photographs the inside of the device or commodity may be provided for the device or commodity. In this case, when the remote controller 30 is directed toward the photographing device and is operated for remote control, the photographing device photographs the inside of the device or commodity. Then, this image data is outputted from the photographing device to the remote controller 30 directly or via the server 14 and is displayed on the image display unit 32 of the remote controller 30. With this construction, it becomes possible for the user to know the internal state of the device or commodity without opening it. Also, by providing a moving mechanism or a zooming mechanism for the photographing device, it becomes possible for the user to know the internal state of the device or commodity in more detail. Note that the photographing device is a CCD camera, for instance.

Also, in the case of a device or commodity having a housing, such as a refrigerator, a storage shed, a desk, or a chest, an IC tag sensor may be installed in the device or commodity and an IC tag may be attached to each item stored in the device or commodity. With this construction, it becomes possible for the user to know what items are stored therein. In this case, when the IC tags and the stored items (goods) are related to each other, it becomes possible to display a list of the stored items on the image display unit 32 of the remote controller 30.

Also, in this embodiment, an IC tag may be provided for each book kept in a bookshelf. By establishing relation between the books kept in the bookshelf and the IC tags attached to the books, it becomes possible to display a list of the books kept in the bookshelf on the image display unit 32 of the remote controller 30. In addition, when the title and outline of each book provided with the IC tag is stored in the server, it also becomes possible to display the outline of the book on the image display unit 32 of the remote controller 30. In this case, it becomes possible for the user to know the outline of the book without taking the book from the bookshelf.

It should be noted here that in this embodiment, the remote controller 30 is not specifically limited and may be a remote controller having an information communication function by voice or the like. For instance, the remote controller 30 may be a PDA or a mobile telephone having the function of the remote controller 30 in this embodiment.

<Second Embodiment>

Next, a second embodiment of the present invention will be described.

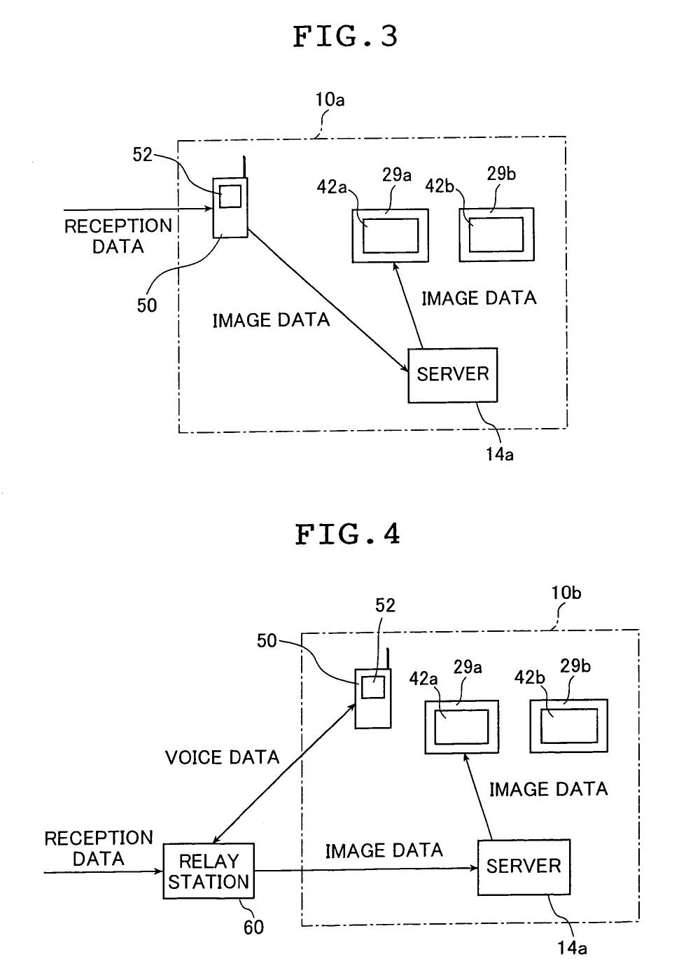

FIG. 3 is a schematic diagram showing a device control system according to the second embodiment of the present invention. As shown in FIG. 3, a device control system 10a in this embodiment includes two television sets (devices) 29a and 29b, a server 14a that controls these television sets 29a and 29b, and a mobile telephone 50 that serves as a control means. The television sets 29a and 29b have display screens 42a and 42b, respectively. Also, a display scheme adopted by these television sets 29a and 29b are not specifically limited and may be a CRT scheme, a liquid crystal display scheme, a scheme using a PDP or an organic EL device, for instance.

In this embodiment, the server 14a has the same function as the server 14 in the first embodiment. Also, like in the first embodiment, in this embodiment, the television sets 29a and 29b are each provided with an IC tag (not shown) and the positions of these television sets 29a and 29b are detected by IC tag sensors (not shown). Further, like in the first embodiment, the positions of the television sets 29a and 29b are grasped by the server 14a.

Also, the mobile telephone 50 has an image display unit 52, on which moving images are displayed, and a user is capable of holding conversion while viewing the moving images. That is, the mobile telephone 50 is a mobile telephone generally called “videophone”. Further, the mobile telephone 50 includes a position/direction detection unit (not shown) that is the same as the position/direction detection unit 36 (see FIG. 2) of the remote controller 30 (see FIG. 2) in the first embodiment, has a transfer mode in which image data of the moving images displayed on the image display unit 52 is transferred to another device having an image display unit, and includes a transmission/reception unit (not shown) for outputting the data and information to the server 14a. This transmission/reception unit has the same construction as the transmission/reception unit 38 (see FIG. 2) of the remote controller 30 in the first embodiment, so that the detailed description thereof will be omitted.

The mobile telephone 50 in this embodiment receives voice data and image data as reception data and allows a user to hold conversion while viewing moving images. Also, the mobile telephone 50 is capable of outputting the image data, out of the reception data, to the server 14a through the transmission/reception unit.

Next, a device control method used in the device control system 10a in this embodiment will be described.

First, when holding conversion using the mobile telephone 50, the user sets the mobile telephone 50 in the transfer mode. Next, position information and direction information concerning the mobile telephone 50 are outputted to the server 14. Then, in the server 14, a television set to be remotely controlled with the mobile telephone 50 is identified with reference to the position information and the direction information concerning the mobile telephone 50 and the positions of the television sets 29a and 29b. In this embodiment, it is assumed that the mobile telephone 50 is directed toward the television set 29a.

Following this, image data, out of reception data of the mobile telephone 50, is outputted to the server 14. Then, the image data is outputted from the server 14 to the television set 29a and images displayed on the image display unit 52 of the mobile telephone 50 are displayed by the television set 29a. In this case, the image display unit 52 and the display screen of the television set 29a differ from each other in size, so that image processing, such as interpolation of the image data, is performed by the server 14 so that appropriate displaying is performed on the display screen 42a.

In this embodiment, it is possible to identify the television set 29a to be remotely controlled with the mobile telephone 50 with reference to the position information and the direction information concerning the mobile telephone 50 and the position information concerning the television sets 29a and 29b. Further, images displayed on the image display unit 52 of the mobile telephone 50 can be displayed by the television set 29a on the display screen 42a thereof. As a result, it becomes possible for the user to hold conversion while viewing images larger than those displayed on the image display unit 52 of the mobile telephone 50.

It should be noted here that in this embodiment, when moving images displayed on the image display unit 52 of the mobile telephone 50 are displayed on the display screen 42a of the television set 29a, for instance, the mobile telephone 50 is not required to display the images on the image display surface 52 and it is sufficient that the mobile telephone 50 outputs only voice information.

<Third Embodiment>

Next, a third embodiment of the present invention will be described.

FIG. 4 is a schematic diagram showing a device control system according to the third embodiment of the present invention. Note that in this embodiment, each construction element that is the same as that in the device control system 10a according to the second embodiment shown in FIG. 3 is given the same reference numeral and the detailed description thereof will be omitted.

A device control system 10b in this embodiment differs from the device control system 10a in the second embodiment in that a relay station 60 receives reception data, separates it into voice data and image data, outputs the voice data to a mobile telephone 50, and outputs the image data to a server 14a. Other constructions are the same as those in the second embodiment, so that the detailed description thereof will be omitted.

In this embodiment, only the voice data is outputted to the mobile telephone 50 and the image data is outputted to the server 14a. Then, the server 14a causes a television set, toward which the mobile telephone 50 is directed, to display images having an appropriate size on the display screen of the television set 29a based on the image data. With this construction, it becomes possible for a user to hold conversion while viewing images displayed by the television set 29a toward which the mobile telephone 50 is directed. That is, it is possible to provide the same effect as in the second embodiment. Also, it is not required for the mobile telephone 50 to output the image data to the server 14a, so that processing that the mobile telephone 50 needs to perform is reduced.

It should be noted here that in the second embodiment and the third embodiment, images are displayed by the television set 29a in addition to or in place of the image display unit 52 of the mobile telephone 50, although the present invention is not limited to this. For instance, image data of images displayed may be stored in a storage apparatus. Also, the image data may be outputted using a printer or a facsimile. Further, the image data may be outputted to a PC or a portable communication device.

In addition, like in the case of image data, voice data may be outputted to the server 14a and stored in a storage apparatus. Also, the voice data may be outputted to a PC or a portable communication device.

<Fourth Embodiment>

Next, a fourth embodiment of the present invention will be described.

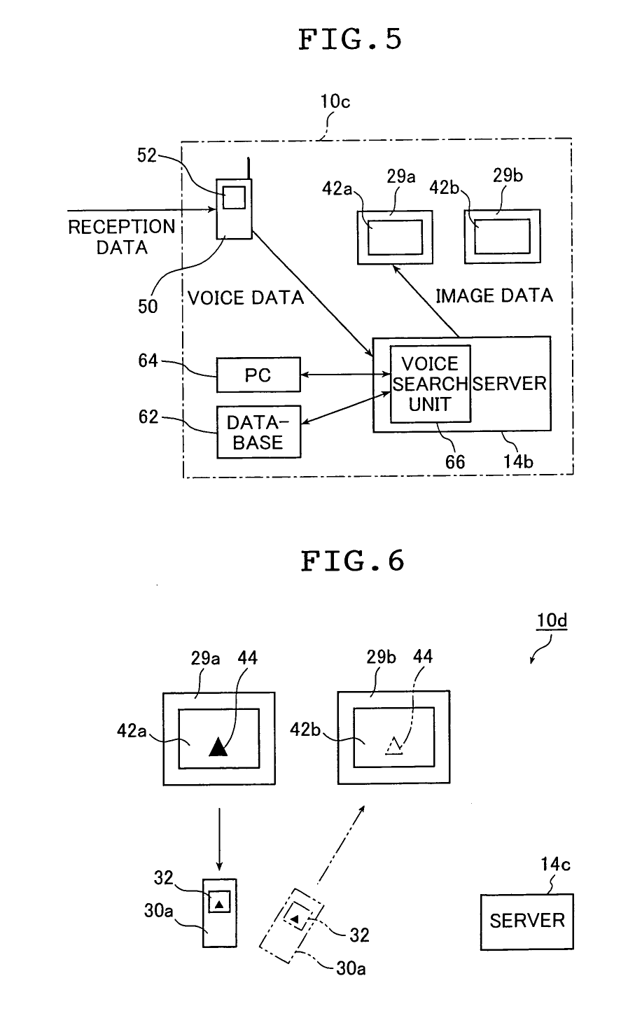

FIG. 5 is a schematic diagram showing a device control system according to the fourth embodiment of the present invention. Note that in this embodiment, each construction element that is the same as that in the device control system 10a according to the second embodiment shown in FIG. 3 is given the same reference numeral and the detailed description thereof will be omitted.

A device control system 10c in this embodiment differs from the device control system 10a in the second embodiment in that a database 62 and a PC 64 are connected to a server 14b, the server 14b is provided with a voice search unit 66, and a mobile telephone 50a has a voice search mode. Other constructions are the same as those in the second embodiment, so that the detailed description thereof will be omitted.

The server 14b has the same construction as the server 14a in the second embodiment except that the voice search unit 66 is provided in this server 14b.

Also, the mobile telephone 50a has the same construction as the mobile telephone 50 in the second embodiment except that the mobile telephone 50a has the voice search mode.

In the database 62, various kinds of data are accumulated. Also, the connection form of this database 62 is not specifically limited. For instance, the database 62 may be installed as a database server. Also, the database 62 may be connected through a network.

The voice search unit 66 recognizes a voice signal (voice contents) inputted by voice from the mobile telephone 50a as a search term and performs a search of the database 62 and the PC 64 based on the search term.

In this embodiment, when the mobile telephone 50a is set in the voice search mode and a search term is inputted from the mobile telephone 50a by voice, the voice search unit 66 recognizes voice data of the search term. Next, the voice search unit 66 performs a search of the database 62 and the PC 64 based on this search term. Then, the server 14 causes a television set closest to the mobile telephone 50a to display a result of this search.

As described above, in this embodiment, it is possible to perform a search of the database 62 and the PC 64 during conversion using the mobile telephone 50a and to cause a television set closest to the mobile telephone 50a to display a result of the search.

It should be noted here that a method of displaying the search result is not specifically limited and it is sufficient that the search result is presented using an image or a document.

Also, the output destination of the search result is not limited to the television set and the search result may be outputted to an output device such as a facsimile, a printer, or a monitor of a PC. In addition, the search result may be outputted to a device having a voice output function such as a stereo system. In this case, the search result is presented by voice.

Further, the voice search unit 66 may recognize incoming voice or outgoing voice during conversion and perform a search using the recognized voice.

Still further, when an image search is performed, it is possible to use a method with which camera information, such as a photographed date and time, a photographed place, or camera control information, is attached to each photographed image as image related information and the image search is performed using the information. Also, a message may be recorded by voice so as to be attached to each photographed image and the image search may be performed based on this message (voice).

Also, it is possible to perform a search of moving images of a broadcasted TV program or the like using a keyword in a manner described below.

For instance, it is possible to perform the search by checking voice data (voice information) attached to each image scene of the moving images against a keyword.

Also, it is possible to perform the search based on the voice data (voice information) using a word expressing a kind of feeling as a keyword. In this case, the kind of feeling corresponding to each piece of voice data (voice information) is judged in a manner described below.

For instance, when a word, such as “ow”, “chickie”, or “zex”, is contained in the voice information, for instance, the kind of feeling corresponding to the voice information is judged as “impatience”.

Also, when a word, such as “whoof”, “jiminy”, or “amazing”, is contained in the voice information, the kind of feeling corresponding to the voice information is judged as “surprise”.

Further, when a word, such as “cold” or “chilly”, is contained in the voice information, its corresponding kind of feeling is judged as “sorrow”. Still further, when a word, such as “Mmm” or “well”, is contained in the voice information, its corresponding kind of feeling is judged as “anxiety (doubt)”. Also, when a word, such as “aah” or “love”, is contained in the voice information, its corresponding kind of feeling is judged as “affection”. Also, if a word, such as “yahoo” or “made it”, is contained in the voice information, its corresponding kind of feeling is judged as “pleasure”. With this construction, it becomes possible to perform the search using a word expressing feeling as a keyword.

<Fifth Embodiment>

Next, a fifth embodiment of the present invention will be described.

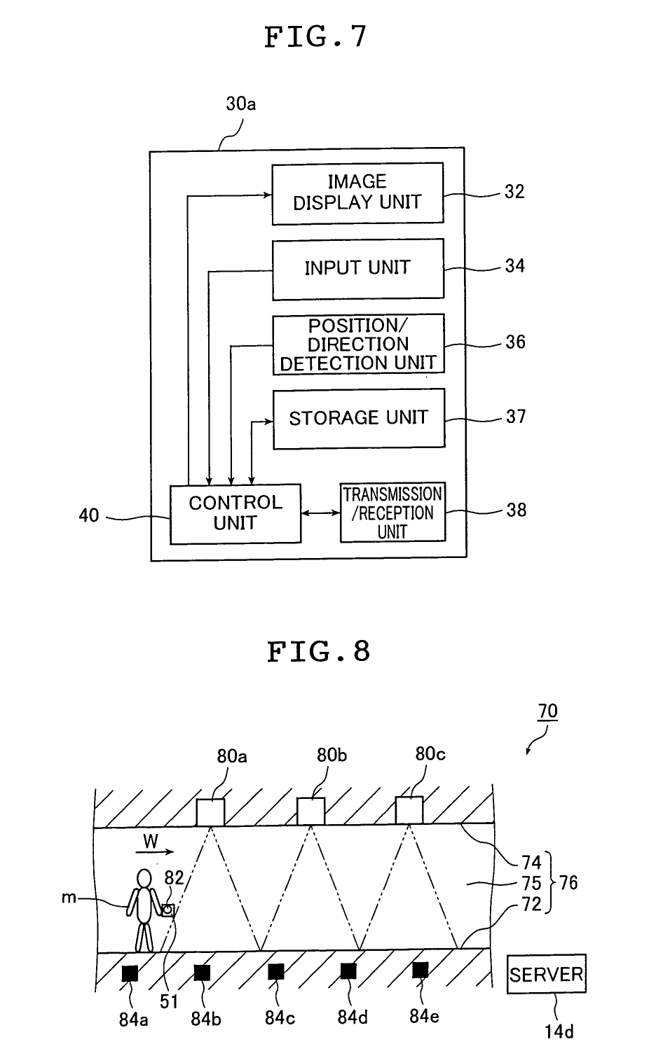

FIG. 6 is a schematic diagram showing a device control system according to the fifth embodiment of the present invention and FIG. 7 is a schematic diagram showing a construction of a remote controller used in the device control system according to the fifth embodiment of the present invention. Note that in this embodiment, each construction element that is the same as that in the device control system 10 according to the first embodiment shown in FIG. 1 is given the same reference numeral and the detailed description thereof will be omitted.

A device control system 10d in this embodiment differs from the device control system 10 in the first embodiment in that not the device and commodity group 20 but two television sets 29a and 29b are to be remotely controlled. Also, a remote controller 30a in this embodiment has a construction that is different from that of the remote controller 30. Other constructions are the same as those in the device control system 10 according to the first embodiment, so that the detailed description thereof will be omitted.

The remote controller 30a in this embodiment differs from the remote controller 30 in the first embodiment in that this remote controller 30a has a data take-in mode (reception function), in which image data of an image displayed on a device, voice data of voice outputted from the device, or data of a document, an image, or the like displayed by the device (when the device is a PC) is taken in directly or via a server 14c, and a data output mode (transmission function) in which the taken-in data is outputted from the remote controller 30a to another device directly or via the server 14c. Also, as shown in FIG. 7, the remote controller 30a in this embodiment differs from the remote controller 30 in the first embodiment in that the remote controller 30a is provided with a storage unit 37 in which the taken-in data is stored. Other constructions are the same as those of the remote controller 30 (see FIG. 2) in the first embodiment. Here, the storage unit 37 is connected to a control unit 40.

In this embodiment, a case will be described as an example in which as shown in FIG. 6, a triangular image 44 is displayed on a display screen 42a of the television set 29a.

First, the remote controller 30a is set in the data take-in mode for taking in data.

Next, the remote controller 30a is directed toward the television set 29a (device to be remotely controlled) and image data of the triangular image 44 displayed by the television set 29a is taken in to the storage unit 37 of the remote controller 30a.

Then, the setting of the remote controller 30a is changed to the data output mode for outputting the data. Following this, data to be outputted is selected, the remote controller 30a is directed toward the television set 29b, and the image data of the triangular image 44 is outputted to the television set 29b. Here, the outputted image data has been subjected to image processing so that appropriate displaying is performed by the television set 29b. Finally, a triangular image 44 based on the outputted image data is displayed on a display screen 42b of the television set 29b.

As described above, in this embodiment, it is possible to temporarily hold the triangular image 44 displayed by the television set 29a in the remote controller 30a and to cause the television set 29b to display the image 44. That is, with the remote controller 30a, it is possible to cause the television set 29b to display the triangular image 44 displayed by the television set 29a.

Here, certain keys of an input unit 34 may be assigned to the taking-in of image data to the remote controller 30a and the outputting of the taken-in data to a device.

It should be noted here that in this embodiment, the image 44 displayed by the television set 29a is copied via the remote controller 30a and is displayed by the different television set 29b, although the present invention is not specifically limited to this.

For instance, the image data may be exchanged via the server 14c in a manner described below. First, in the take-in mode, the television set 29a to be remotely controlled is pointed with the remote controller 30a, a take-in signal for taking in data through the remote controller 30a is outputted to the server 14c, and the server 14c takes in the image data of the image 44 displayed by the television set 29a that has been pointed. Next, in the output mode, the remote controller 30a is directed toward the television set 29b, the server 14c performs image processing on the image data held therein so that appropriate displaying is performed on the display screen 42b of the television set 29b, and the image data having been subjected to the image processing is outputted from the server 14c to the television set 29b.

Also, in this embodiment, description has been made by taking, as an example, a case where an image is copied, although the present invention is not limited to this. For instance, the remote controller 30a may have a function of taking in data (including a file) of voice, moving images, a document, a program, or other contents and a function of outputting the data (file). Also, specific data (including a file) among data (including files) stored in a PC may be designated and the specific data (including a file) may be taken in.

Even in this case, it does not matter whether the exchange of data (including a file) between the remote controller and a device is performed directly or via the server 14c.

Further, when a device that is an output destination includes a storage unit, data (including a file) or the like of voice, moving images, a document, a program, or other contents may be outputted to the storage unit of the device. Also, even in the case of image data, it is not necessarily required to cause a device to display an image of the image data.

Still further, the remote controller 30a is provided with the image display unit 32 in this embodiment, although this image display unit 32 is not an indispensable construction element. For instance, when the image display unit 32 is not provided, the remote controller 30a may emit a sound in order to notify a user of taking-in of data (including a file) and outputting of data (including a file).

Also, in this embodiment, the image data of the triangular image 44 displayed by the television set 29a is copied, although the image data itself may be taken in. That is, the image data in the television set 29a may be moved to the storage unit 37 of the remote controller 30a. In this case, the displaying of the image 44 by the television set 29a is terminated. Here, it is of course possible to move the image data to the server 14 instead of the remote controller 30a.

As described above, with the remote controller 30a in this embodiment, it becomes possible to copy, cut, and paste an image or moving images displayed by a device, a sound emitted from a device, an image or a document displayed on a monitor of a PC, and the like directly or via the server 14c. Note that it is sufficient that the remote controller 30a has at least one of the function of taking-in data and the function of outputting data.

Further, the remote controller 30a is used in this embodiment, although the present invention is not limited to this. For instance, a mobile telephone or a PDA having the function of the remote controller 30a in this embodiment may be used instead of the remote controller 30a.

In this embodiment, when such a mobile telephone is used instead of the remote controller 30a, it becomes possible to read data of an image, a document, or the like from a PC and to copy the read data to another device during conversation, for instance. In addition, it also becomes possible to cause the other device to display the image, document, or the like during conversation.

<Sixth Embodiment>

Next, a sixth embodiment of the present invention will be described.

FIG. 8 is a schematic diagram showing a device control system according to the sixth embodiment of the present invention. Note that in this embodiment, each construction element that is the same as that in the first embodiment shown in FIG. 1 is given the same reference numeral and the detailed description thereof will be omitted.

In this embodiment, a device control system 70 is described in which image displaying is controlled in a passage 76 surrounded by a floor 72, a ceiling 74, and walls 75. The passage 76 extends in one direction and a person m can move along a moving direction W in the passage 76.

Below the floor 72, IC tag sensors 84a to 84e are provided at regular intervals along a longitudinal direction of the passage 76. Also, in the ceiling 74, projectors (image display means) 80a to 80c for displaying an image at a place (specific place) pointed with a mobile telephone 51 to be described later are provided at regular intervals along the longitudinal direction of the passage 76.

The mobile telephone 51 (pointing means) used in this embodiment has a direction detection means. Also, the mobile telephone 51 in this embodiment is provided with an IC tag 82 for positional detection. With the IC tag 82 and the IC tag sensors 84a to 84e provided below the floor 72, it becomes possible to detect and identify the position of the mobile telephone 51. As a result, the position of the person m carrying the mobile telephone 51 is also identified.

It should be noted here that as the direction detection means of the mobile telephone 51, it is possible to use a direction detection means that is the same as the direction detection means of the remote controller 30 (see FIG. 2) in the first embodiment.

Also, as in the above embodiments, in this embodiment, the positions of the respective projectors 80a to 80c, the position of the mobile telephone 51 identified by means of the IC tag 82 and the IC tag sensors 84a to 84e, and the direction of the mobile telephone 51 are grasped by a server 14d. The server 14d has the same construction as in the first embodiment, so that the detailed description thereof will be omitted.

In this embodiment, when the mobile telephone 51 is directed toward the floor by the person m, the position of the mobile telephone 51 is identified by means of the IC tag 82 and the IC tag sensor 84a, and the direction of the mobile telephone 51 is detected by the direction detection means. Then, a position of the floor 72 pointed by the person m is determined by the server 14d.

In the example illustrated in FIG. 8, first, an image is displayed by the projector 80a at the pointed position of the floor 72. Then, the display position of the image is moved in accordance with a movement of the person m. In more detail, a projector that displays the image is sequentially switched in the order of the projector 80a, the projector 80b, and the projector 80c in accordance with the movement of the person m. With this construction, it becomes possible to display the image so that an initial distance between the display position of the image and the position of the person m in the moving direction is maintained regardless of the moving speed of the person m.

The image displayed in this manner is not specifically limited. For instance, in a passage in a department store, the image may be an advertisement. Also, in a hall, the image may be a notification of special events. In these cases, it becomes possible for a user to see various advertisements in a passage in a department store and to see a notification of special events in a hall.

It should be noted here that the display position is not limited to the floor 72 and may be the ceiling 74 or the wall 75 so long as it is possible to display an image with the projectors 80a to 80c. Also, the projectors 80a to 80c are provided in this embodiment, although the present invention is not limited to this. For instance, a moving mechanism may be provided for a single projector. In this case, it is possible to display an image while maintaining a positional relation between the person m and a display position by changing the display position in accordance with the movement of the person m using the moving mechanism.

Also, a fine adjustment of the display position may be performed by issuing a voice command using the mobile telephone 51.

It should be noted here that in this embodiment, in place of the mobile telephone 51, a remote controller may be used as in the case of the device control system 10 in the first embodiment. In this case, the construction of the remote controller used in place of the mobile telephone 51 differs from that of the remote controller 30 in the first embodiment in that the image display unit 32 is not provided, the IC tag 82 is provided, and the direction detection means is provided in place of the position/direction detection unit 36. Other constructions of the remote controller in this case may be the same as those of the remote controller 30 in the first embodiment.

Also, IC tags may be provided below the floor 72 and an IC tag sensor may be provided for the mobile telephone 51 or the remote controller. Further, the places, at which the IC tag sensors are provided, are not limited to the floor and may be the ceiling, the wall, or the like so long as the position of the mobile telephone can be detected.

In each of the embodiments described above, the remote controller or the mobile telephone has the function of detecting its position and direction (compass direction). In the present invention, however, when a device closest to the remote controller or the mobile telephone is caused to display an image, for instance, it is sufficient that the device has a position detection unit. Also, when an image is displayed with a touch of a device, the position and direction detection function becomes unnecessary.

Also, in each of the embodiments described above, a photographing means, such as a camera, may be provided which is capable of photographing the remote controller or the mobile telephone and an image analysis means may be further provided which determines the position and direction of the remote controller or the mobile telephone by analyzing an image photographed by the photographing means, such as an image of the remote controller or the mobile telephone, an image of the arm of a user holding the remote controller or the mobile telephone, or an image expressing a motion of the arm. In this case, both of the function of detecting the position of the remote controller or the mobile telephone and the function of detecting the direction thereof become unnecessary. Also, in this case, a device to be remotely controlled with the remote controller or the mobile telephone is identified by the server based on a result of the image analysis.

Further, in each of the embodiments described above where a mobile telephone is used, the address and map information concerning each person registered in the mobile telephone may be stored in the server. In this case, the place, in which each registered person lives, is identified in the server. When the mobile telephone is directed in any one of the north, south, east, and west, the telephone number of each registered person, who lives in the compass direction in which the mobile telephone is directed, is displayed. For instance, it is assumed that the relatives of a user live in the south and the user wishes to call them. In this case, the mobile telephone is directed in the south and the telephone numbers of the registered persons living in the south are listed up and are displayed. Then, the user selects the telephone number of his/her relatives from among the displayed telephone numbers. With this construction, it becomes possible for the user to call them without inputting a telephone number.

Also, when a device having an image display unit is used under a state where its single display screen is divided into multiple display areas, one of the multiple display areas obtained through the division may be pointed and selected with the remote controller or the mobile telephone. With this construction, in the case of a television set having a large display screen, for instance, it becomes possible to divide the screen into a right screen area and a left screen area and to display different images in the respective screen areas.

As described in detail above, with the device control system, the device control method, and the program according to the present invention, it becomes possible to identify a device to be remotely controlled with a control means such as a remote controller or a mobile telephone. As a result, it becomes possible for a user to remotely control, using the control means, a device, out of multiple devices, that the user wishes to remotely control.

1. A device control system comprising:
plural devices arranged in a predetermined space;
position detection means for detecting an arrangement position of each of said plural devices in said predetermined space;
control means for remotely controlling said plural devices, said control means being carried by a user of said plural devices, being directed toward said arrangement position of one device of said plural devices to be remotely controlled, and detecting a direction and a position of itself in said predetermined space at the time of remote control of said one device; and
a management apparatus that acquires said arrangement position of each of said plural devices detected by said position detection means, and identifies said one device to be remotely controlled by said control means based on said arrangement position of each of said plural devices and said direction and said position of said control means,
wherein said control means remotely controls said identified one device via said management apparatus.

2. The device control system according to claim 1, wherein:
at least one of said plural devices comprises an image display apparatus; and
when said identified one device is said image display apparatus, said management apparatus outputs image data to said image display apparatus to display a predetermined image, and said image display apparatus displays said predetermined image based on said image data.

3. The device control system according to claim 1, wherein:
said control means has a voice communication function;
said management apparatus includes a voice search unit for searching information based on voice contents inputted from said control means and a database in which said information to be searched by said voice search unit has been stored; and
said voice search unit searches said database for information matching said voice contents based on said voice contents inputted by voice with said control means, and when said one device to be remotely controlled with said control means comprises an image display apparatus, said management apparatus outputs a searched result by said voice search unit to said image display apparatus.

4. The device control system according to claim 3, wherein:
said searched result is image data; and
said management apparatus transmits said image data to said image display apparatus and causes said image display apparatus to display an image based on the image data.

5. The device control system according to claim 1, wherein:
at least one of said plurality of devices comprises a photographing device provided for a article;
said control means includes an image display unit;
said photographing device photographs said article and outputs data of a photographed image of said article to said control means directly or via said management apparatus; and
said control means displays an image of said article on said image display unit based on the data of said photographed image.

6. The device control system according to claim 1, wherein:
said control means has an image display unit; and
after acquiring information concerning said one device to be remotely controlled with said control means, said management apparatus transmits said information concerning said one device to said control means to display said information concerning said one device on said image display unit.

7. The device control system according to claim 1,
wherein said control means has at least one of a reception function of acquiring data concerning said one device to be remotely controlled directly or via said management apparatus and a transmission function of outputting said data concerning said one device to be remotely controlled directly or via said management apparatus.

8. The device control system according to claim 1, wherein:
said plurality of devices contain a first device and a second device to be remotely controlled by said control means; and
said control means has a function of causing said first device as a target of remote control to transmit data held therein to said management apparatus and a function of causing said management apparatus to transmit data held therein to said second device as a target of the remote control.

9. A device control system comprising:
image display means for displaying an image at a specific place;
pointing means for pointing a predetermined place, said pointing means being carried by a user and having a function of detecting a position and a direction of itself; and
a management apparatus that acquires said position and said direction detected by said pointing means, identifies as said specific place said predetermined place pointed by said pointing means based on said acquired position and said acquired direction, and causes said image display means to display the image at said identified predetermined place,
wherein said image is displayed by said image display means at said predetermined place pointed by said pointing means via said management apparatus.

10. The device control system according to claim 9,
wherein said pointing means further has an information communication function.

11. A device control method comprising the steps of:
detecting an arrangement position of each of plural devices arranged in a predetermined space;
detecting a position and a direction of control means that is carried by a user of said plural devices and has a function of remotely controlling said plural devices;
identifying one device of said plural devices toward which said control means is directed by said user, based on detection results of said arrangement position of each of plural devices and said position and said direction of said control means; and
remotely controlling said identified one device of said plural devices by means of said control means.

12. A program for implementing a device control method comprising:
a step of acquiring first position information concerning plural devices arranged in a predetermined space from first position detection means for detecting an arrangement position of each of said plural devices, and identifying said arrangement position of each of said plural devices in said predetermined space based on said acquired first position information;
a step of acquiring second position information concerning a control means for remotely controlling said plural devices from a second position detection means for detecting a position and a direction of said control means, and identifying said position and said direction of said control means based on said second position information;
a step of identifying one device of said plural devices , toward which said control means is directed, based on said identified arrangement position of each of said plural devices and said identified position and said identified direction of said control means; and
a step of outputting, to said control means, a signal for obtaining a state where said identified one device is controllable with said control means.
